(19) United States
(12) Patent Application Publication
(10) Pub. No.: US 2014/0099565 A1
(43) Pub. Date: Apr. 10, 2014

(54) FUEL CELL COMPRISING A PROTON-EXCHANGE MEMBRANE, HAVING AN INCREASED SERVICE LIFE

(71) Applicants: Remi Vincent, Grenoble (FR); Sylvie Escribano, Grenoble (FR); Alejandro Franco, Aniens (FR); Laure Guetaz, Grenoble (FR); Anne-Gaelle Mercier, Chanbery (FR); Christine Nayoze, La Riviere (FR)

(72) Inventors: Remi Vincent, Grenoble (FR); Sylvie Escribano, Grenoble (FR); Alejandro Franco, Aniens (FR); Laure Guetaz, Grenoble (FR); Anne-Gaelle Mercier, Chanbery (FR); Christine Nayoze, La Riviere (FR)

(73) Assignee: Commissariat a l'energie atomique et aux energies alternatives, Paris (FR)

(21) Appl. No.: 14/008,641

(22) PCT Filed: Mar. 29, 2012
(86) PCT No.: PCT/EP2012/055619

§ 371 Date: Nov. 15, 2013

(30) Foreign Application Priority Data
Mar. 31, 2011 (FR) 1152743

(51) Int. Cl. H01M 8/10

(52) U.S. Cl. CPC H01M 8/1004
USPC 429/482

(57) ABSTRACT

A fuel cell having a proton-exchange membrane, an anode, and a cathode. The anode and cathode are fixed on opposing sides of the proton-exchange membrane. The anode demarcates a flow conduit between a molecular-hydrogen inlet area and a molecular-hydrogen outlet area. A quantity of catalyst at the molecular-hydrogen outlet area is smaller than a quantity of catalyst at the molecular-hydrogen inlet area. The anode also has a thickness that decreases continuously between the molecular-hydrogen inlet and outlet areas.

The invention pertains to fuel cells and especially to proton-exchange membrane fuel cells.

Fuel cells are especially envisaged as an energy source for future mass-produced motor vehicles. A fuel cell is an electrochemical device that converts chemical energy directly into electrical energy. A fuel cell comprises a stack of several cells in series. Each cell generates voltage of the order of 1 Volt and their stacking enables the generation of a power supply voltage of a higher level, for example of the order of 100 volts.

Among the known types of fuel cells, we can cite especially the proton-exchange membrane called the PEM. Such fuel cells have particularly interesting properties of compactness. Each cell has an electrolytic membrane enabling only the passage of protons and not the passage of electrons. The membrane enables the separation of the cell into two compartments to prevent direct reaction between the reactant gases. The membrane comprises an anode on a first face and a cathode on a second face, this assembly being usually designated by the term “membrane/electrode assembly”.

At the anode, molecular hydrogen or hydrogen (H2) used as fuel is ionized to produce protons passing through the membrane. The electrons produced by this reaction migrate to a flow plate and then pass through an electrical circuit external to the cell to form an electrical current. At the cathode, oxygen is reduced and reacts with the protons to form water.

The fuel cell can comprise several flow plates, for example made of metal, stacked on one another. The membrane is positioned between two flow plates. The flow plates can comprise channels and holes to guide the reactants and products to and from the membrane. The plates are also electrically conductive so as to form collectors for the electrons generated at the anode. Gas diffusion layers are interposed between the electrodes and the flow plates and are in contact with the flow plates.

The service life of a proton-exchange membrane fuel cell is still far too short. Fuel cells undergo ageing characterized, for example, by the water-logging of the cathode or by an irreversible deterioration of the nano-materials of the cathode, for example due to the deterioration of the carbon support and of the catalyst. These phenomena lead to a gradual deterioration of the performance of the cell.

Managing the presence of water in the fuel cell is relatively complicated. Indeed, the cathode reaction implies the generation of water, and water is also necessary to maintain the proton conductivity of the membrane. Thus, it can be necessary to humidify the reactant gases beforehand so that the membrane can be humidified. However, an excessive quantity of water can cause the flooding of the catalytic sites and thus cause an interruption of the working of the cell by blocking the access of oxygen to the reactant sites.

Certain scientific studies have also noted that the deterioration of performance could be due to a gradual change in the nanostructural properties of the cathode. Certain studies have also shown that the thickness of the cathode active layer diminishes greatly after only a few hours of operation. Such deterioration is attributed to a reaction of corrosion of the carbon support of the cathode by water in the following reaction:

C+2H₂O→CO₂+4H⁺+4e⁻

The redox potential of this reaction is about 0.2V (SHE). Since the cathode potential of the cell is generally greater than 0.2V, the conditions of such a reaction are then met. In addition, the constant presence of large quantities of water in the cathode favors the reaction.

Besides, the corrosion can be accentuated during the stopping/starting phases or during the power cycles of the cell. Indeed, the membrane is not perfectly impermeable to gases. Thus, molecular oxygen or oxygen (O2) gets diffused through the membrane to reach the anode. The quantity of hydrogen (H2) available can prove to be insufficient to react with the oxygen (O2) in the anode. The oxygen (O2) in the anode then reacts with the protons generated by the corrosion reaction. This oxygen (O2) thus acts as a proton pump and accentuates the corrosion phenomenon. The corrosion of the carbon support reduces the catalytic surface of the cathode, induces the separation of the platinum particles from the support and increases the electrical contact resistance between the cathode and its gas diffusion layer.

Other factors of deterioration are the oxidation, dissolving and re-crystallization of platinum. Electrochemical maturing also induces an increase in the size of the platinum particles, which is unfavorable to the operation of the cell.

These different phenomena continue to affect the service life of the fuel cells far too greatly for large-scale applications. The increased use of fuel cells in products distributed to the general public will require an appreciable increase in their service life and a reduction of their manufacturing costs.

The document JP2005317492A describes a fuel cell with a proton-exchange membrane aimed at minimizing the quantity of catalyst material. The thickness of the layer of catalyst on the anode is diminished in stages, between the inlet and outlet areas of the fuel. Such an anode is difficult to make without a truly prohibitive cost.

The document by Lim Katie, Oh Hyung-Suk and Kim Hansung, “Use of a carbon nanocage as a catalyst support in polymer electrolyte membrane fuel cells”, Electrochemistry Communications 2009, vol. 11, no 6, pp. 1131-1134, describes nanometric structures to form a carbon support on which platinum is fixed to form a cathode. Such a cathode has a substantially increased resistance to corrosion but a cost of fabrication incompatible with industrial-scale production for large-scale distribution.

There is therefore a need for a fuel cell which has both increased service life and reduced cost of fabrication. The invention thus relates to a fuel cell comprising:

a proton-exchange membrane;

an anode and a cathode fixed on either side of the proton-exchange membrane, the anode demarcating a flow conduit between a hydrogen (H2) inlet area and a hydrogen (H2) outlet area and having a quantity of catalyst at the hydrogen (H2) outlet that is smaller than the quantity of catalyst at the hydrogen (H2) inlet.

The thickness of the anode decreases continuously between the inlet area and the outlet area.

According to one variant, the anode has a concentration in catalyst at the inlet area that is at least twice the concentration in catalyst at the outlet area.

According to another variant, the anode comprises a catalyst fixed to a support including graphite.

According to yet another variant, the cathode delimits a flow conduit between an oxygen (O2) inlet area and a water outlet area, the water outlet area being positioned so as to be facing the hydrogen (H2) inlet area.

Other features and advantages of the invention shall appear more clearly from the following description, given by way of an indication that is in no way exhaustive, with reference to the appended drawings, of which:

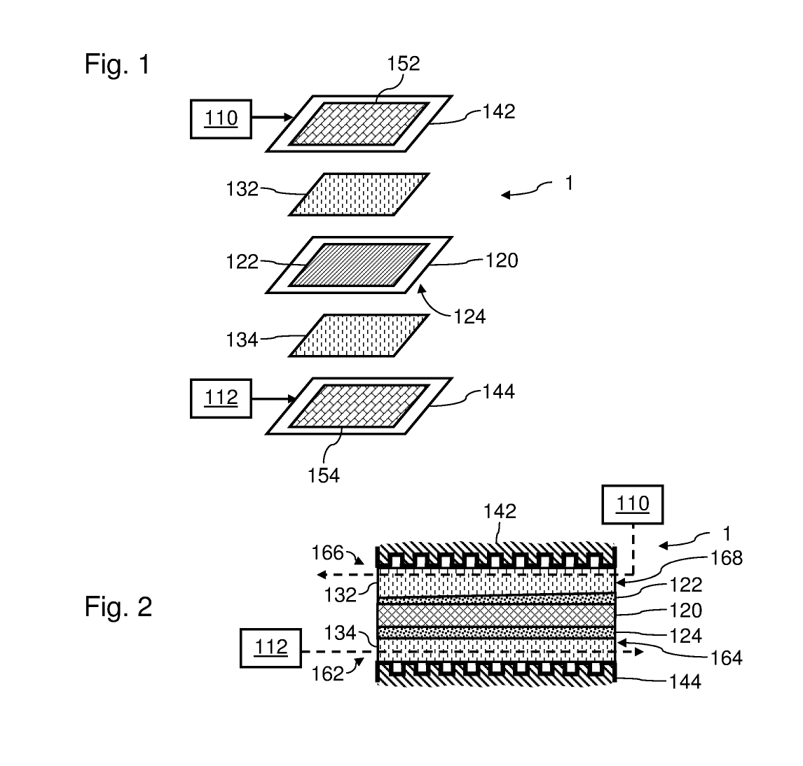

FIG. 1 is a schematic exploded view in perspective of a cell of a fuel cell;

FIG. 2 is a view in section of a cell of a fuel cell according to a first embodiment of the invention;

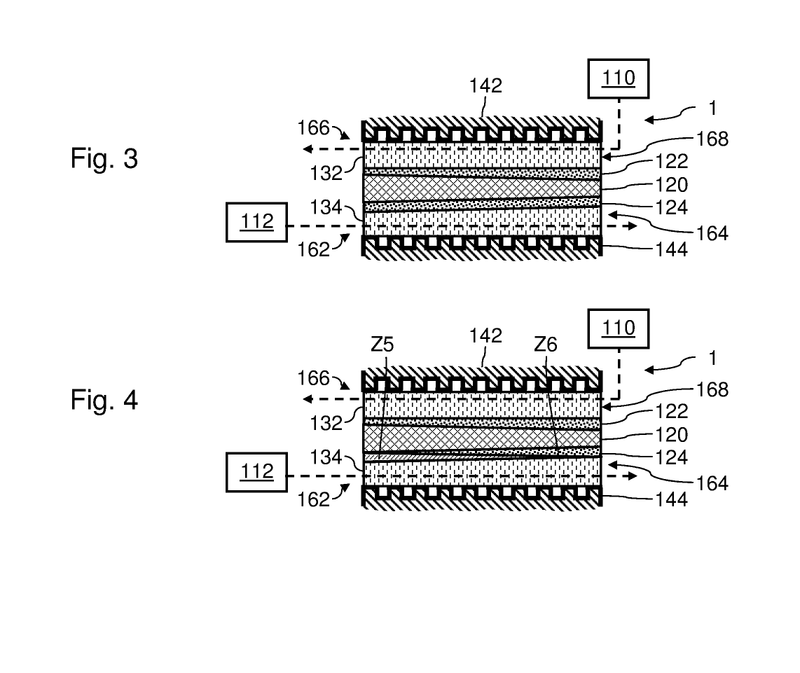

FIG. 3 is a view in section of a cell of a fuel cell according to a first variant of the first embodiment;

FIG. 4 is a view in section of a cell of a fuel cell according to a second variant of the first embodiment.

The inventors have noted that proton-exchange membrane fuel cells show a generally greater degree of wear on the cathode in the oxygen (O2) inlet area.

The invention proposes a fuel cell in which the anode has a quantity of catalyst at the hydrogen (H2) outlet area that is smaller than the quantity of catalyst at the hydrogen (H2) inlet area. The thickness of the anode decreases continuously between the inlet area and the outlet area.

Thus, the invention makes it possible optimally to improve protection against the corrosion of the cathode at the oxygen inlet by reducing the possibility of reaction of oxygen (O2) diffused towards the anode through the membrane, without lowering the performance of the fuel cell and at a reasonable production cost.

FIG. 1 is a schematic exploded view in perspective of a cell 1 of a fuel cell. The cell 1 is of a proton-exchange membrane or polymer electrolyte membrane type. The cell 1 of the fuel cell comprises a fuel source 110 feeding hydrogen (H2) to a first inlet 168 of the cell. The cell 1 also has a first outlet 166 to remove excess hydrogen (H2). The cell 1 has a flow conduit extending between the first inlet and the first outlet. The cell 1 also has an air source 112 feeding a second inlet 162 of the cell with air, the air containing oxygen (O2) used as an oxidant. The cell 1 furthermore has a second outlet 164 to remove the excess oxygen (O2), the water from the reaction and heat. The cell 1 has a flow conduit extending between the second inlet 162 and the second outlet 164. The cell 1 can also have a cooling circuit not shown.

The cell 1 has an electrolyte layer 120 formed for example by a polymer membrane. The cell 1 also has an anode 122 and a cathode 124 placed on either side of the electrolyte 120 and fixed to the electrolyte 120. The cell 1 has flow guide plates 142 and 144 positioned so as to be respectively facing the anode 122 and the cathode 144. The cell 1 furthermore has a gas diffusion layer 132 positioned in the flow conduit between the anode 122 and the guiding plate 142. The cell 1 furthermore has a gas diffusion layer 134 positioned in the flow conduit between the cathode 124 and the guiding plate 144.

The plates 142 and 144 have faces oriented towards the electrolyte layer 120 respectively comprising areas 152 and 154 comprising a set of grooves or channels. The areas 152 and 154 comprise the grooves or channels enabling hydrogen (H2) and air to be conveyed respectively into the cell 1.

The plates 142 and 144 are made out of metal such as stainless steel in a manner known per se. The plates 142 and 144 are usually designated as bipolar plates, a same component generally comprising a guide plate 142 belonging to a cell and a guide plate 144 belonging to an adjacent cell. The plates 142 and 144 are conductive and are used to collect the current generated by the cell 1.

The electrolyte layer 120 forms a semi-permeable membrane enabling proton conduction while at the same time being impermeable to gases present in the cell 1. The electrolyte layer 120 also prevents a passage of electrons between the anode 122 and the cathode 124. The layer of electrolyte 120 however does not form a perfect barrier to gas diffusion and especially to oxygen (O2) diffusion.

During the operation of the fuel cell, air flows between the electrolyte 120 and the plate 144, and hydrogen (H2) flows between the electrolyte 120 and the guiding plate 142. At the anode 122, hydrogen (H2) is ionized to produce protons which pass through the electrolyte 120. The electrons produced by this reaction are collected by the plate 142 and applied to an electrical load connected to the cell 1 to form an electrical current. At the cathode 124, oxygen is reduced and reacts with the protons to form water. The reactions at the anode and the cathode are set as follows:

H₂→2H⁺+2e⁻ at the anode;

4H⁺+4e⁻+O₂→2H₂O at the cathode. When it is in operation, a cell 1 usually generates a DC voltage of the order of 1V between the anode and the cathode.

In the embodiment that shall be described here below, the outlet 166 faces the inlet 162 and the inlet 168 faces the outlet 164. Hydrogen (H2) and oxygen (O2) therefore flow in opposite senses inside the cell 1. The diffusion of oxygen (O2) is of particularly critical importance at the inlet 162, this zone being the most subject to corrosion. Indeed, at the inlet 162, only a limited part of this oxygen (O2) has then reacted with the cathode 124, and the inlet 162 is at the hydrogen (H2) removal outlet on the anode side 122 and therefore at a zone where the quantity of hydrogen (H2) that can react with the diffused oxygen (O2) is further reduced. The diffused oxygen (O2) at the inlet 162 therefore tends to react with protons coming from the corrosion reaction of a carbon support of the cathode 124.

FIG. 2 is a schematic view in section of the cell 1 of the fuel cell according to a first embodiment of the invention. The anode 122 has a concentration of homogenous catalyst. The thickness of the anode 122 at the outlet 166 is however smaller than its thickness at the inlet 168. Thus, the quantity of catalyst at the outlet 166 is smaller than the quantity of catalyst at the inlet 168. The thickness of the anode 122 can decrease continuously between the inlet 168 and the outlet 166. The thickness of the anode 122 can also decrease exponentially.

Such a configuration makes it possible to obtain an anode 122 with distinct quantities of catalyst at the fuel inlet and outlet, and for relatively limited cost.

The anode 122 generally has a catalyst layer including for example a catalyst such as platinum supported on a graphitized support and a proton-conducting ionomer such as for example the product distributed under the commercial reference Nafion. Platinum is used for its catalyst properties. The formation of such an anode 122 could be obtained by inkjet printing methods.

Tests made with a fuel cell according to the invention showed a very sharp improvement in the service life of the cells for constant quantities of catalyst, with the voltage of the cells of the invention dropping at a far later stage and the loss of carbon mass at the cathode taking place far more slowly.

According to a first improvement of the invention, the thickness of the membrane 120 at the oxygen (O2) inlet 162 is greater than its thickness at the outlet 164. In practice, the part of the membrane 120 at the inlet has a proton resistance higher than its proton resistance at the outlet 164. Thus, the diffusion of oxygen (O2) at the inlet 162 is reduced.

Using a smaller thickness of membrane 120 at the outlet 164 fosters the crossing of the protons into an area that is less critical for the corrosion of the cathode 124. Thus, the performance of the cell 1 is only marginally reduced in return for a substantial gain in service life.

According to one variant of the first improvement illustrated in FIGS. 3 and 4, the membrane 120 has a thickness that decreases continuously between the inlet 162 and the outlet 164. Such a membrane 120 can be made in a particularly easy way, for example by a process of casting combined with evaporation, enabling easy control over the local thickness of the membrane 120. Such a variation of thickness can be obtained by locally depositing a greater or smaller quantity of material during the casting.

Advantageously, the thickness of the membrane 120 at the inlet 162 is greater by at least 40% than the thickness of the membrane 120 at the outlet 164.

The cathode 124 generally comprises a layer of catalyst including for example platinum fixed to a graphitized support and an proton-conducting ionomer. The platinum is used for its properties as a catalyst. The cathode 124 can have a composition and a thickness that are homogenous.

The anode 122 and the cathode 124 can for example comprise supports achieved by association of carbon and ionomer aggregates. Platinum nanoparticles are then fixed to these aggregates. The ionomer of the cathode or the anode can be identical to the ionomer used to form the membrane. The cathode 124 and the anode 122 can be made by application of ink to the membrane 120 or to a respective gas diffusion layer. The ink can typically comprise the combination of a solvent, an ionomer and platinized carbon.

The gas diffusion layer 132 is used to diffuse hydrogen (H2) from a flow channel of the plate 142 towards the anode 122.

The gas diffusion layer 134 is used to diffuse air from a flow channel of the plate 144 towards the cathode 124.

The gas diffusion layers 132 and 134 can for example be obtained in a manner known per se in the form of fiber, felt or graphite fabric on which a hydrophobic agent is fixed, for example polytetrafluoroethylene. Advantageously, the gas diffusion layers 132 and 134 have a thickness five times greater than the thickness of the assembly including the membrane 120, the anode 122 and the cathode 124. Since the gas diffusion layers 132 and 134 are generally compressible, they make it possible to absorb the heterogeneity of thickness of the membrane/electrode assembly. The gas diffusion layers 132 and 134 could for example have a thickness of 200 μm to 500 μm.

According to a second improvement of the invention, the cathode 124 comprises a support of the catalyst material including a first graphitized material to which the catalyst is fixed. The support of the cathode 124 also includes a second material to which the catalyst is fixed, this material having a resistance to corrosion by oxygen greater than the resistance of the graphitized material. The quantity of this second material at the oxygen (O2) inlet 162 is greater than the quantity of this second material at the outlet 164. The phenomenon of corrosion of the cathode 124 is thus diminished without excessively affecting the cost price of the cell.

The second material could for example include fullerene, doped SnO₂ or doped TiO₂. This latter material should enable diffusion of the gases and a diffusion of the protons. Limiting the use of this second material to the necessary zones contains the cost price of the cathode 124.

In one variant illustrated in FIG. 4, the cathode 124 comprises two layers Z5 and Z6. The layer Z5 and Z6 are superimposed in the direction of their thickness. The layer Z5 has a homogenous concentration of reinforced material. The layer Z6 has a homogenous concentration in graphitized material. The thickness of the layer Z5 decreases continuously between the inlet 162 and the outlet 164. The thickness of the layer Z6 increases continuously between the inlet 162 and the outlet 164. The assembling of the layers Z5 and Z6 has a constant thickness.

Although this is not illustrated, it is also possible to make a cathode 124 having a layer with a concentration of a reinforced material that decreases between the inlet 162 and the outlet 164.

1-4. (canceled)

5. A manufacture comprising a fuel cell, said fuel cell comprising a proton-exchange membrane, an anode, and a cathode, wherein said anode is fixed on a first side of said proton-exchange membrane, wherein said cathode is fixed on a second side of said proton-exchange membrane, wherein said anode demarcates a flow conduit between a molecular-hydrogen inlet area and a molecular-hydrogen outlet area, wherein a quantity of catalyst at said molecular-hydrogen outlet area is smaller than a quantity of catalyst at said molecular-hydrogen inlet area; and wherein said anode has a thickness that decreases continuously between said molecular-hydrogen inlet area and said molecular-hydrogen outlet area.

6. The manufacture of claim 5, wherein said anode has a first concentration of catalyst at said molecular-hydrogen inlet area, wherein said anode has a second concentration of catalyst at said molecular-hydrogen outlet area, and wherein said first concentration is at least twice said second concentration.

7. The manufacture of claim 5, wherein said anode comprises a catalyst fixed to a support including graphite.

8. The manufacture of claim 5, wherein said cathode delimits a flow conduit between a molecular-oxygen inlet area and a water outlet area, and wherein said water outlet area is positioned to be facing said molecular-hydrogen inlet area.
